(19) United States
(12) Patent Application Publication
(10) Pub. No.: US 2025/0131227 A1
(43) Pub. Date: Apr. 24, 2025

(54) MOBILE COMMUNICATION TERMINAL, CODE DISPLAY METHOD AND STORAGE MEDIUM

(71) Applicant: NEC Corporation, Minato-ku, Tokyo (JP)

(72) Inventor: Hajime Suzuki, Tokyo (JP)

(73) Assignee: NEC Corporation, Minato-ku, Tokyo (JP)

(21) Appl. No.: 18/694,463

(22) PCT Filed: Oct. 19, 2021
(86) PCT No.: PCT/JP2021/038656

§ 371 Date: Mar. 22, 2024

(51) Int. Cl. G06K 19/06; H04M 1/72454

(52) U.S. Cl. CPC G06K 19/06112; H04M 1/72454

(57) ABSTRACT

A mobile communication terminal 10 includes a reception unit that accepts an instruction to display a code by using an input/output unit 102, and a display control unit that causes an undisplayed code to be displayed when the display control unit detects a trigger indicating that the code is ready to be read. An undisplay application 103B that is a program for the mobile communication terminal causes the mobile communication terminal 10 to function as; a code monitoring unit that monitors a screen displayed on a touch panel 102A of an input/output unit 102 and detects whether or not a code is displayed; an undisplay unit that undisplays the code; and a display control unit that causes the undisplayed code to be displayed when the display control unit detects a trigger indicating that the mobile communication terminal is ready for the code to be read.

### TECHNICAL FIELD

The present invention relates to a mobile communication terminal, a code display method, and a storage medium.

### BACKGROUND ART

In recent years, mobile communication terminals such as smartphones display a code on their display screen, and this code is read by a code reader included in a money registry machine such as a POS (Point of Sales) register in a store or the like to make a payment (see Patent Literature 1). Also, in home delivery lockers and product receiving lockers, the code displayed on the display screen of a smartphone is read by a code reader, and after authentication of the code, the locker door is unlocked to allow users to receive products.

### CITATION LIST

### Patent Literature

[PTL 1] Japanese Unexamined Patent Application Publication No. JP2018-074557

### SUMMARY OF INVENTION

### Technical Problem

As described above, processes such as payment processing and unlocking locker doors are performed by having the code readers included in various code readers, such as POS registry machines and the like, home delivery lockers, and product receiving lockers, read the displayed codes. However, there have been problems in which the code displayed on the display screen is secretly captured and used illegally by a third party.

In this regard, a technology has been proposed in which the code is initially undisplayed and the code is made visible by touching two points on the screen with fingers. However, even with this technology, it is not possible to effectively prevent the code from being secretly captured.

The main object of the present invention is to provide a mobile communication terminal, a code display method, and a storage medium that effectively prevent a code from being secretly captured.

### Solution to Problem

According to a first aspect of the present invention, there is provided a mobile communication terminal, including: a reception unit that accepts an instruction to display a code by using an input/output unit; and a display control unit that causes the code, the code being undisplayed, to be displayed when the display control unit detects a trigger indicating that the code is ready to be read.

According to a second aspect of the present invention, there is provided a code display method, including: monitoring, by using a code monitoring unit, a screen displayed on a touch panel of an input/output unit and detects whether or not a code is displayed; undisplaying, by using an undisplay unit, the code when the code is detected; and causing, by using a display control unit, the undisplayed code to be displayed when the display control unit detects a trigger indicating that the mobile communication terminal is ready for the code to be read.

According to a third aspect of the present invention, there is provided a computer-readable storage medium storing a program for a mobile communication terminal, wherein the program causes the mobile communication terminal to function as; a code monitoring unit that monitors a screen displayed on a touch panel of an input/output unit and detects whether or not a code is displayed; an undisplay unit that undisplays the code when the code is detected; and a display control unit that causes the undisplayed code to be displayed when the display control unit detects a trigger indicating that the mobile communication terminal is ready for the code to be read.

### Advantageous Effects of Invention

According to the individual aspects of the present invention, a mobile communication terminal, a code display method, and a storage medium that effectively prevent a code from being secretly captured are provided. The advantageous effects of the present invention are not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of a configuration of a mobile communication terminal.

FIG. 2 is a flowchart illustrating an example of an operation of the mobile communication terminal.

FIG. 3 is a diagram illustrating a specific configuration of a mobile communication terminal of a first example embodiment.

FIG. 4 is a flowchart illustrating the operation of the mobile communication terminal of the first example embodiment.

FIG. 5 is a flowchart illustrating an operation of a mobile communication terminal of a second example embodiment.

FIG. 6 is a diagram illustrating a first example undisplayed screen that is displayed on a touch panel on which no code is displayed.

FIG. 7 is a diagram illustrating a second example undisplayed screen that is displayed on the touch panel on which no code is displayed.

FIG. 8 is a diagram illustrating a display screen that is displayed on the touch panel on which a code is displayed.

FIG. 9 a diagram illustrating a calculation screen displayed on a POS input/output unit of a money registry machine.

FIG. 10 is a diagram illustrating an example of a hardware configuration of the mobile communication terminal of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

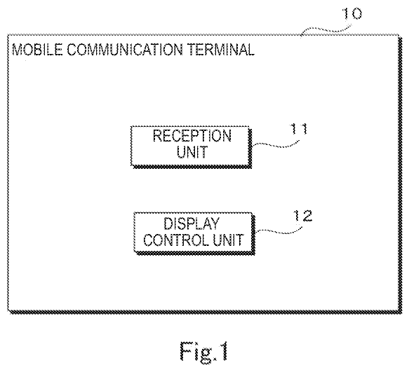

FIG. 1 is a diagram illustrating an outline of a configuration of a mobile communication terminal 10 of the present application. As shown in FIG. 1, the mobile communication terminal 10 of the present application includes a reception unit 11 that accepts an instruction to display a code by using an input/output unit, and a display control unit 12 that causes an undisplayed code to be displayed when the display control unit 12 detects a trigger indicating that the code is ready to be read.

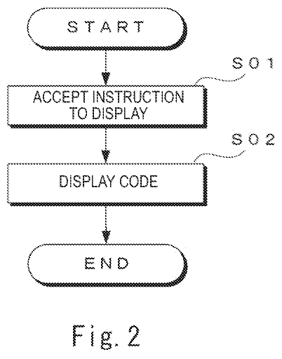

FIG. 2 is a flowchart illustrating an example of an operation of the mobile communication terminal 10. As shown in FIG. 2, the mobile communication terminal 10 accepts an instruction to display a code by using the input/output unit (step 01). When the mobile communication terminal 10 detects a trigger indicating that the code is ready to be read, the mobile communication terminal 10 causes an undisplayed code to be displayed (step 02).

The mobile communication terminal 10 does not continue to display a code used for payment, or the like, but causes an undisplayed code to be displayed in response to detecting a trigger that indicates that the code is ready to be read. Therefore, there is virtually no time for a third party to secretly capture the code. Thus, according to the present application, secret capture of the code is effectively prevented.

The following is a detailed description of a mobile communication terminal, a program for a mobile communication terminal, an operation system program for a mobile communication terminal and a code display method, which effectively prevents secretly capturing a code, according to an example embodiment of the present invention. Note that the following description uses a money registry machine as an example of a code reader, but the code reader may include any device that operates by reading a code displayed on the mobile communication terminal 10, such as a delivery locker, a product receiving locker, or a washer/dryer in a laundromat, in addition to the money registry machine.

### First Example Embodiment

### Configuration of Mobile Communication Terminal

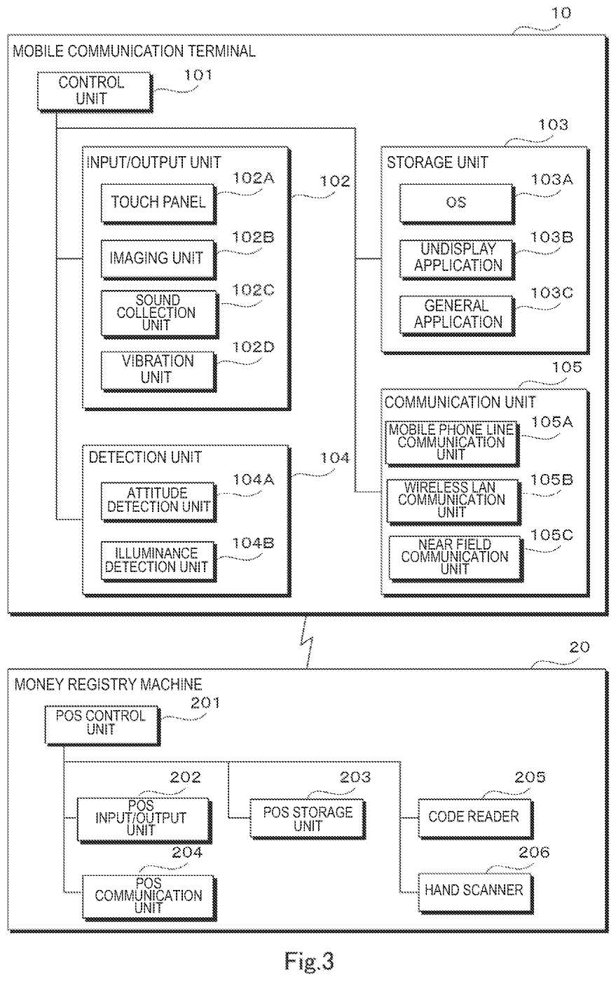

FIG. 3 is a diagram illustrating a specific configuration of the mobile communication terminal 10 in this example embodiment. The mobile communication terminal 10 can be a so-called smartphone. As shown in FIG. 3, the mobile communication terminal 10 includes a control unit 101, an input/output unit 102, a storage unit 103, a detection unit 104, and a communication unit 105.

The control unit 101 includes an arithmetic apparatus such as a CPU (Central Processing Unit).

The input/output unit 102 includes a touch panel 102A that performs input by contact and display, an imaging unit 102B that includes an imaging device such as a camera and a light, a sound collection unit 102C that includes a sound collection device such as a microphone, and a vibration unit 102D that includes a vibration device such as a vibrator.

The storage unit 103 includes a storage device such as a ROM (Read Only Memory), a RAM (Random Access Memory), or a nonvolatile storage device such as a flash memory.

The storage unit 103 stores an OS (Operating System) 103A that is a so-called operation system program, an undisplay application 103B that is a program for the mobile communication terminal, and a general application 103C.

The OS 103A controls operation of each device in the mobile communication terminal 10, as well as instructs and monitors execution and suspension of each application.

The undisplay application 103B monitors contents of a screen displayed on the touch panel 102A and when a code, such as a bar code or 2D code, is displayed, the undisplay application 103B undisplays the code.

The general application 103C causes a code to be displayed on the touch panel 102A for payment or the like.

The control unit 101 reads the OS 103A from the storage unit 103 and sequentially executes the OS 103A, operates each device under the supervision of the OS 103A, and sequentially reads and executes each application.

The detection unit 104 includes an attitude detection unit 104A that includes a gyro sensor or the like to detect an attitude of the mobile communication terminal 10, and an illuminance detection unit 104B that includes a photoelectric element that detects brightness and outputs a signal.

The communication unit 105 includes a mobile phone line communication unit 105A that communicates via a mobile phone line, a wireless LAN communication unit 105B that communicates via a wireless LAN (local area network), and a short-range communication unit 105C that performs short-range communication such as a Bluetooth (registered trademark). The communication unit 105 communicates with a money registry machine such as a POS register via the short-range communication unit 105C.

The money registry machine 20 can be a so-called POS register or a money registry machine using a so-called tablet terminal. The money registry machine 20 using a tablet terminal will be described below as an example.

The money registry machine 20 includes a POS control unit 201, a POS input/output unit 202, a POS storage unit 203, a POS communication unit 204, a code reader 205, and a hand scanner 206.

The POS control unit 201 includes an arithmetic apparatus such as a CPU.

The POS input/output unit 202 includes an input/output device such as a touch panel, camera, and microphone.

The POS storage unit 203 stores an operation system program as well as a payment application that registers money and makes a payment.

The control unit 201 reads out and sequentially executes the operation system, operates each device under supervision of the operation system, and reads out and executes each application sequentially.

The POS communication unit 204 includes a short-range communication device such as a Bluetooth (registered trademark) or the like that performs short-range communication.

The code reader 205 emits a laser beam onto a code, reads the code from reflected light, converts the reflected light into an electrical signal, and outputs the electrical signal.

The hand scanner 206 is a portable device that emits a laser beam onto a code, reads out the code from reflected light, converts the reflected light into an electrical signal, and outputs the electrical signal.

### Operation of Mobile Communication Terminal

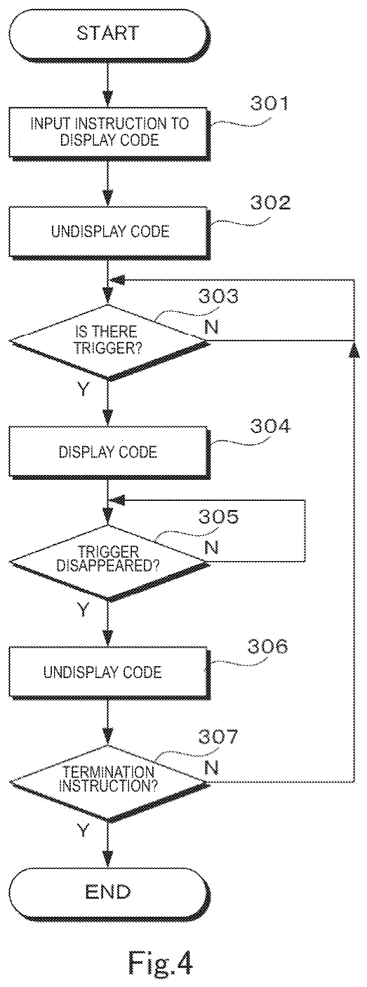

FIG. 4 shows a flowchart illustrating an operation of the mobile communication terminal 10 in this example embodiment. As shown in FIG. 4, in step 301, the control unit 101 inputs an instruction to display a code from the touch panel 102A to the general application 103C by using the reception unit 11.

In step 302, the control unit 101 monitors the screen displayed on the touch panel 102A by using the undisplay application 103B. When the control unit 101 determines that a code is displayed on the touch panel 102A, the control unit 101 undisplays the code.

The control unit 101 undisplays the code by one of the following methods using the display control unit 12.
(1) The control unit 101 removes the displayed code from the screen.
(2) The control unit 101 displays a mask image at the position where the code is displayed to make the code invisible.

In step 303, the control unit 101 determines whether there is a trigger to cause the code to be displayed by using the undisplay application 103B. When the control unit 101 determines that there is the trigger (Y in step 303), the flow proceeds to step 304, and when the control unit 101 does not determine that there is the trigger (N in step 303), the flow returns to step 303.

Here, the trigger will be explained. The trigger means a state of the mobile communication terminal 10 in which the mobile communication terminal 10 is in a state where a code is ready to be read.

Examples of the trigger include any of the following states.
(1) In case the control unit 101 detects that the touch panel 102A of the mobile communication terminal 10 is facing downward by using the attitude detection unit 104A.
(2) In case the control unit 101 detects a laser light emitted from the code reader 205 or the hand scanner 206 by using the imaging unit 102B. The control unit 101 uses the imaging unit 102B to determine whether the laser light is emitted from the code reader 205 or the hand scanner 206 by color and light intensity.
(3) In case the control unit 101 detects that the touch panel 102A of the mobile communication terminal 10 is close to the code reader 205 or the hand scanner 206 by using the illuminance detection unit 104B. The control unit 101 determines that the touch panel 102A of the mobile communication terminal 10 is brought closer to the code reader 205 or the hand scanner 206 when the illuminance detected by using the illuminance detection unit 104B becomes darker than a threshold value.
(4) In case the control unit 101 detects that a predetermined sound is generated by using the sound collection unit 102C, for example, a “beep” sound, which is a sound signal to start reading the code, or a sound saying “Reading of the code will begin.”.

In step 304, the control unit 101 displays the code. When the code is removed, the control unit 101 displays the removed code, and when the mask image is displayed, the control unit 101 removes the mask image from the screen.

At this time, the control unit 101 vibrates the mobile communication terminal 10 by using the vibration unit 102D or turns on the light of the imaging unit 102B. Alternatively, the control unit 101 may notify the user that the code has been displayed by generating a sound such as “beep” from a speaker included in the mobile communication terminal 10, so that the user can check that the code has been displayed without checking the screen.

In step 305, the control unit 101 determines whether the trigger has been disappeared. When the control unit 101 determines that the trigger has been disappeared (Y in step 305), the flow proceeds to step 306, and when the control unit 101 does not determine that the trigger has been disappeared (N in step 305), the flow returns to step 305.

Here, the term “the trigger has been disappeared” means a state in which the control unit 101 is no longer able to detect the above-mentioned trigger.

In step 306, the control unit 101 again undisplays the code.

In step 307, the control unit 101 determines whether a termination instruction to the general application 103C has been input. When the control unit 101 determines that the termination instruction has been input (Y in step 307), the control unit 101 terminates processing of the general application 103C, and when the control unit 101 does not determine that the termination instruction has been input (N in step 307), the flow returns to step 303.

As described above, the mobile communication terminal 10 of the first example embodiment includes the reception unit 11, which accepts an instruction to display a code by using the input/output unit 102, and the display control unit 12, which causes to be displayed an undisplayed code when the display control unit 12 detects a trigger indicating that the code is ready to be read.

Moreover, the undisplay application 103B, which is the program for the mobile communication terminal of this example embodiment, causes the mobile communication terminal 10 to function as a code monitoring unit, an undisplay unit, and a display control unit. The code monitoring unit monitors a screen displayed on the touch panel 102A of the input/output unit 102 and detects whether or not a code is displayed. The undisplay unit undisplays the code when the code is detected. When the display control unit detects a trigger indicating that the code is ready to be read, the display control unit causes the undisplayed code to be displayed.

Furthermore, in a code display method of this example embodiment, the code monitoring unit monitors a screen displayed on the touch panel 102A of the input/output unit 102 and detects whether or not a code is displayed. The undisplay unit undisplays the code when the code is detected. When the display control unit detects a trigger indicating that the mobile communication terminal 10 is ready for the code to be read, the display control unit causes the undisplayed code to be displayed.

As described above, the mobile communication terminal 10 according to the first example embodiment does not continue to display a code used for payment, or the like, but causes a code that is an undisplayed code to be displayed in response to detecting a trigger indicating that the code is ready to be read. Therefore, there is practically no time during which a third party can secretly capture the code. Therefore, according to the first example embodiment, it is effective to provide the mobile communication terminal that effectively prevents a code from being secretly captured.

### Second Example Embodiment

### Configuration of the Mobile Communication Terminal

The configuration of the mobile communication terminal 10 of a second example embodiment is the same as that of the mobile communication terminal 10 of the first example embodiment. Therefore, description of the configuration of the mobile communication terminal 10 of the second example embodiment is omitted.

### Operation of the Mobile Communication Terminal

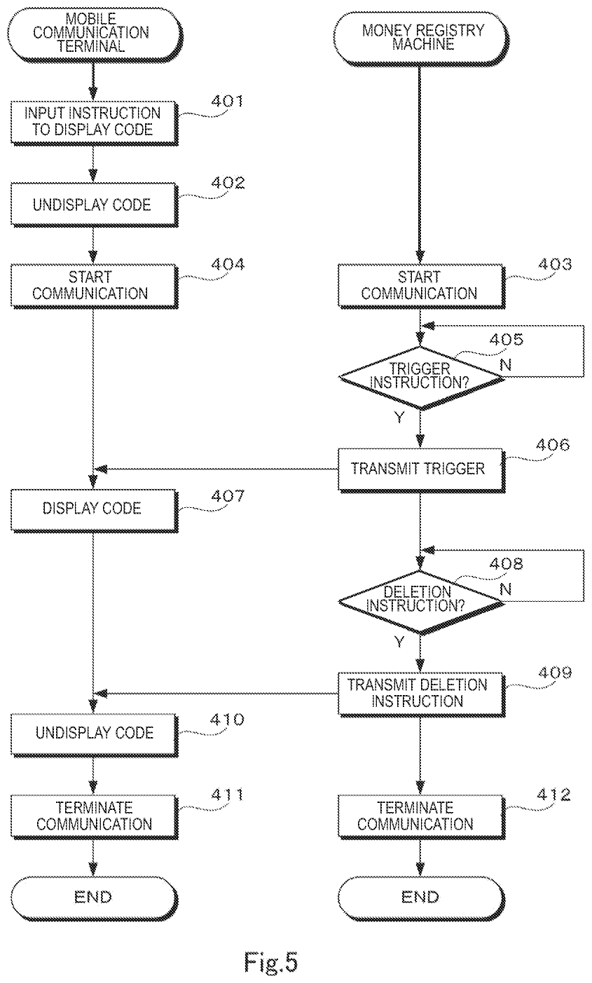

FIG. 5 is a flow chart illustrating an operation of the mobile communication terminal 10 in this example embodiment. As shown in FIG. 5, in step 401, the control unit 101 inputs an instruction to display a code from the touch panel 102A to the general application 103C by using the reception unit.

In step 402, the control unit 101 monitors a screen displayed on the touch panel 102A by using the undisplay application 103B. When the control unit 101 determines that a code is displayed on the touch panel 102A, the control unit 101 undisplays the code.

The control unit 101 uses the display control unit 12 to undisplay the code by one of the following methods.
(1) A method of removing the displayed code from the screen.
(2) A method of displaying a mask image that makes the code invisible at the position where the code is displayed.

In step 403, the POS control unit 201 starts communication with the mobile communication terminal 10 when the POS control unit 201 determines that the mobile communication terminal 10 has entered the range where the mobile communication terminal 10 can communicate by a short-range communication device by using the POS communication unit 204.

In step 404, the control unit 101 starts communication with the money registry machine 20 in response to a request for communication from the money registry machine 20.

In step 405, the POS control unit 201 determines whether there is a trigger instruction. When the POS control unit 201 determines that there is the trigger instruction (Y in step 405), the flow proceeds to step 406, and when the POS control unit 201 does not determine that there is the trigger instruction (N in step 405), the flow returns to step 405.

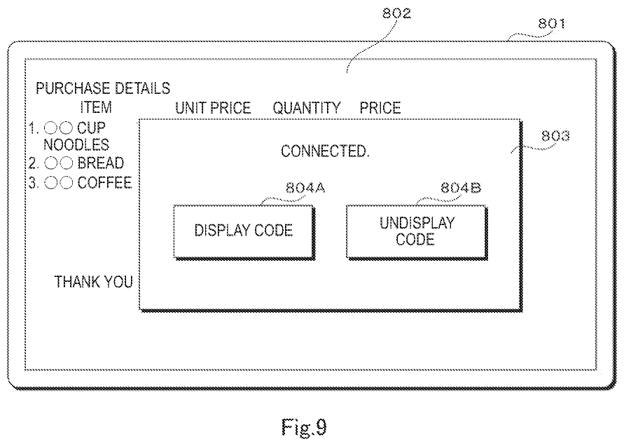

Here, the trigger instruction means pressing a code display button 804A (see FIG. 9), which is displayed on the touch panel of the POS input/output unit 202 and causes the mobile communication terminal 10 to display a code.

An operator of the money registry machine 20 presses the code display button 804A after confirming that a user has made the mobile communication terminal 10 ready to read the code. Note that when the money registry machine 20 includes a separate user screen, the POS control unit 201 can also cause the code display button to be displayed separately on the user screen. In this case, the user presses the code display button at an arbitrary timing.

In step 406, the POS control unit 201 transmits a trigger to the mobile communication terminal 10 to cause the code to be displayed on the mobile communication terminal 10.

In step 407, the control unit 101 displays the code when the control unit 101 receives the trigger. When the code has been removed, the control unit 101 displays the removed code, and when a mask image has been displayed, the control unit 101 removes the mask image from the screen.

In step 408, the POS control unit 201 determines whether there is a deletion instruction. When the POS control unit 201 determines that there is the deletion instruction (Y in step 408), the flow proceeds to step 409, and when the POS control unit 201 does not determine that there is the deletion instruction (N in step 408), the flow returns to step 408.

Here, the deletion instruction means pressing a code undisplay button 804B (see FIG. 9) displayed on the touch panel of the POS input/output unit 202, which causes the mobile communication terminal 10 to undisplay the code.

When an operator of the money registry machine 20 confirms that the money registry machine 20 has completed reading the code, the operator presses the code undisplay button 804B. Note that when the money registry machine 20 includes a separate user screen, the POS control unit 201 can also cause the code undisplay button to be displayed separately on the user screen. In this case, a user presses the code undisplay button at an arbitrary timing.

In step 409, the POS control unit 201 transmits to the mobile communication terminal 10 an undisplay trigger that causes the code to be undisplayed on the mobile communication terminal 10.

In step 410, the control unit 101 undisplays the code again when the control unit 101 receives the undisplay trigger.

In step 411, the control unit 101 terminates the communication with the money registry machine 20.

In step 412, the POS control unit 201 terminates communication with the mobile communication terminal 10.

As described above, the mobile communication terminal 10 in the second example embodiment causes an undisplayed code to be displayed in response to a trigger from the money registry machine 20.

Moreover, the undisplay application 103B, which is the program for the mobile communication terminal, causes the mobile communication terminal 10 to function as a code monitoring unit, an undisplay unit, and a display control unit. The code monitoring unit monitors a screen displayed on the touch panel 102A of the input/output unit 102 and detects whether or not a code is displayed. The undisplay unit undisplays a code when the code is detected. When the display control unit receives a trigger indicating that the code is ready to be read from the money registry machine 20, the display control unit causes the undisplayed code to be displayed.

Therefore, according to the second example embodiment, it is effective to provide the mobile communication terminal that enables a code to be reliably read by the money registry machine 20 and also effectively prevents the code from being secretly captured.

### Third Example Embodiment

### Configuration of Mobile Communication Terminal

The configuration of the mobile communication terminal 10 of a third example embodiment is the same as that of the mobile communication terminal 10 of the first example embodiment, except that the undisplay application 103B of the mobile communication terminal 10 of the first example embodiment is embedded in the OS 103A.

### Operation of Mobile Communication Terminal

The operation of the mobile communication terminal 10 in this example embodiment is the same as that of the mobile communication terminal 10 in the first example embodiment, except that the OS 103A performs the operation of the undisplay application 103B.

The OS 103A, which is the operation system program for the mobile communication terminal of this example embodiment, causes the mobile communication terminal 10 to function as a reception unit, a code monitoring unit, an undisplay unit, and a display control unit. The reception unit accepts an instruction to display a code by using the input/output unit 102. The code monitoring unit monitors the screen displayed on the touch panel 102A of the input/output unit 102 and detects whether or not a code is displayed. The undisplay unit undisplays the code when the code is detected. When the display control unit detects a trigger indicating that the code is ready to be read, the display control unit causes the undisplayed code to be displayed.

Therefore, according to the third example embodiment, it is effective to provide the mobile communication terminal that effectively prevents a code from being secretly captured without launching the undisplay application 103B.

### Fourth Example Embodiment

### Configuration of Mobile Communication Terminal

The configuration of the mobile communication terminal 10 of a fourth example embodiment is the same as that of the mobile communication terminal 10 of the second example embodiment, except that the undisplay application 103B of the mobile communication terminal 10 of the second example embodiment is embedded in the OS 103A.

### Operation of Mobile Communication Terminal

The operation of the mobile communication terminal 10 in this example embodiment is the same as that of the mobile communication terminal 10 in the second example embodiment, except that the OS 103A performs the operation of the undisplay application 103B.

The OS 103A, which is the operation system program for the mobile communication terminal of this example embodiment, causes the mobile communication terminal 10 to function as a reception unit, a code monitoring unit, an undisplay unit, and a display control unit. The reception unit accepts an instruction to display a code by using the input/output unit 102. The code monitoring unit monitors the screen displayed on the touch panel 102A of the input/output unit 102 and detects whether or not the code is displayed. The undisplay unit undisplays the code when the code is detected. When the display control unit receives a trigger from the money registry machine 20 indicating that the code is ready to be read, the display control unit causes the undisplayed code to be displayed.

Therefore, according to this example embodiment, it is effective to provide the mobile communication terminal that effectively prevents the code from being secretly captured without launching the undisplay application 103B.

### Fifth Example Embodiment

### Configuration of Mobile Communication Terminal

The configuration of the mobile communication terminal 10 of a fifth example embodiment is the same as that of the mobile communication terminal 10 of the first example embodiment, except that the undisplay application 103B of the mobile communication terminal 10 of the first example embodiment is embedded in the general application 103C.

### Operation of Mobile Communication Terminal

The operation of the mobile communication terminal 10 of this example embodiment is the same as that of the mobile communication terminal 10 of the first example embodiment, except that the general application 103C performs the operation of the undisplay application 103B.

The general application 103C, which is the program for the mobile communication terminal of this example embodiment, causes the mobile communication terminal 10 to function as a code monitoring unit, an undisplay unit, and a display control unit. The code monitoring unit detects a presence or absence of a code displayed on the touch panel 102A of the input/output unit 102. The undisplay unit undisplays the code when the code is detected. When the display control unit detects a trigger indicating that the code is ready to be read, the display control unit causes the undisplayed code to be displayed.

Therefore, according to the fifth example embodiment, it is effective to provide the mobile communication terminal that effectively prevents the code from being secretly captured without launching the undisplay application 103B.

### Sixth Example Embodiment

### Configuration of Mobile Communication Terminal

The configuration of the mobile communication terminal 10 of a sixth example embodiment is the same as that of the mobile communication terminal 10 of the second example embodiment, except that the undisplay application 103B of the mobile communication terminal 10 of the second example embodiment is embedded in the general application 103C.

### Operation of Mobile Communication Terminal

The operation of the mobile communication terminal 10 of this example embodiment is the same as that of the mobile communication terminal 10 of the second example embodiment, except that the general application 103C performs the operation of the undisplay application 103B.

The general application 103C, which is the program for the mobile communication terminal of this example embodiment, causes the mobile communication terminal 10 to function as a reception unit, a code monitoring unit, an undisplay unit, and the display control unit. The reception unit accepts an instruction to display a code by using the input/output unit 102. The code monitoring unit detects a presence or absence of the code to be displayed on the touch panel 102A of the input/output unit 102. The undisplay unit undisplays the code when the code is detected. When the display control unit receives a trigger indicating that the code is ready to be read from the money registry machine 20, the display control unit causes the undisplayed code to be displayed.

Therefore, according to the sixth example embodiment, it is effective to provide the mobile communication terminal that effectively prevents a code being secretly captured without launching the undisplayed code application 103B.

### Description of Display Screen

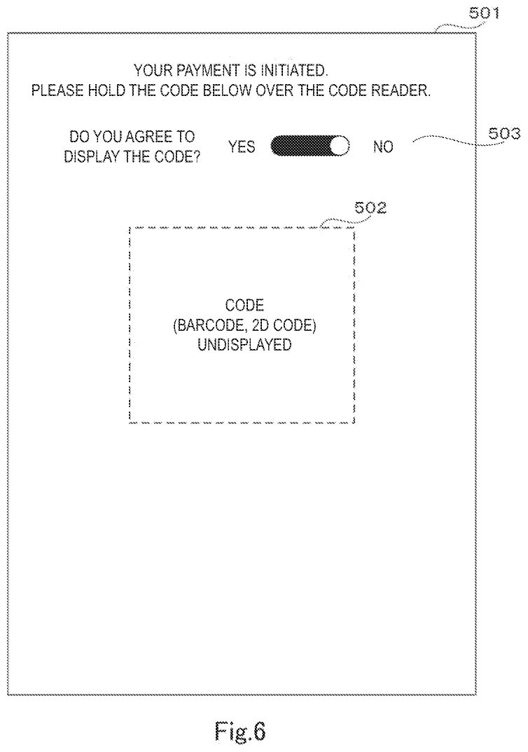

FIG. 6 is a diagram illustrating a first example undisplayed screen 501 that is displayed on the touch panel 102A on which no code is displayed in each example embodiment. As shown in FIG. 6, in the first example undisplayed screen 501, the code is removed and no code is displayed in area 502. Note that the control unit 101 may display a frame line or a guide in the first example undisplayed screen 501 to indicate a display position of the code, as shown by the broken line in FIG. 6.

To force the code to be displayed, a user operates the mobile communication terminal 10 to set a consent button 503 to “Yes”. When the control unit 101 detects that the consent button is “Yes”, the control unit 101 displays the code regardless of a presence or absence of a trigger.

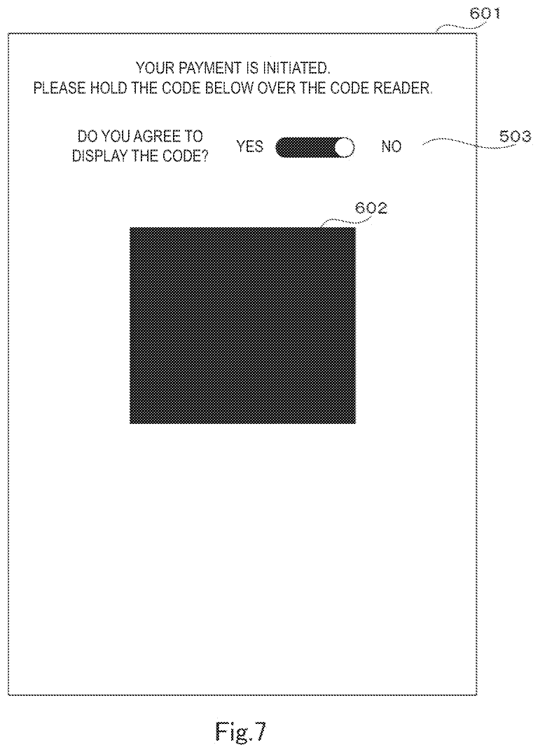

FIG. 7 is a diagram illustrating a second example undisplayed screen 601 that is displayed on the touch panel 102A on which no code is displayed in each example embodiment. As shown in FIG. 7, in the second example undisplayed screen 601, a mask image 602 is displayed at the display position of a code, so that the code is not visible.

To force the code to be displayed, a user operates the mobile communication terminal 10 to set the consent button 503 to “Yes”. When the control unit 101 detects that the consent button is “Yes”, the control unit 101 displays the code regardless of a presence or absence of a trigger.

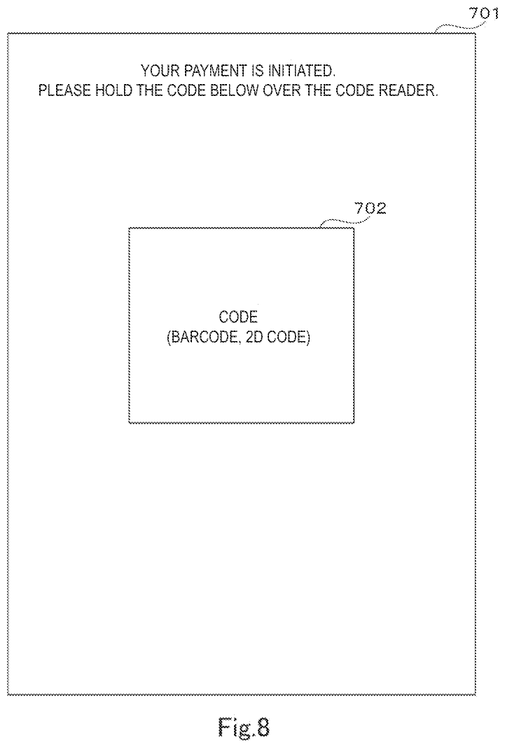

FIG. 8 is a diagram illustrating a display screen 701 that is displayed on the touch panel 102A on which a code is displayed in each example embodiment. As shown in FIG. 8, when the control unit 101 detects or receives a trigger and determines that the consent button is “Yes”, the control unit 101 displays a code 702 on the touch panel 102A.

FIG. 9 is a diagram illustrating a calculation screen 802 displayed on the POS input/output unit 202 of a tablet 801 of the money registry machine 20 in the second example embodiment, the fourth example embodiment, and the sixth example embodiment. As shown in FIG. 9, the POS control unit 201 displays a confirmation pop-up 803 when communication with the mobile communication terminal 10 is established.

The confirmation pop-up 803 includes a code display button 804A that instructs the money registry machine 20 to transmit a trigger to the mobile communication terminal 10, and a code undisplay button 804B that instructs the money registry machine 20 to transmit an instruction to undisplay a code to the mobile communication terminal 10.

Thus, the effect is that the operator of the money registry machine 20 can safely control that the code on the mobile communication terminal 10 is displayed or undisplayed. The effect is that a user can safely control that the code on the mobile communication terminal 10 is displayed or undisplayed when a separate user screen is included on the money registry machine 20.

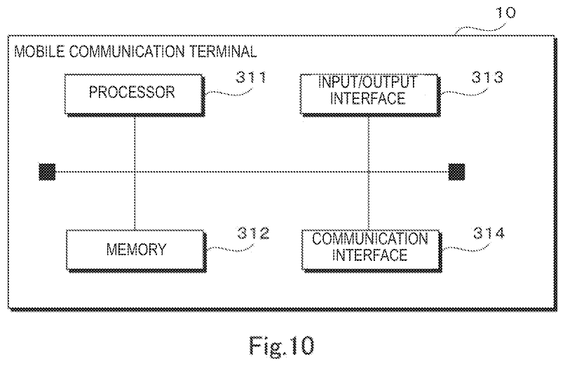

Next, details of a hardware regarding an individual apparatus of the present application will be described. FIG. 10 is a diagram illustrating an example of a hardware configuration of the mobile communication terminal 10.

The mobile communication terminal 10 can be configured by an information processing apparatus (a so-called computer) and has a configuration illustrated as an example in FIG. 10. For example, the mobile communication terminal 10 includes a processor 311, a memory 312, an input-output interface 313, a communication interface 314, etc. The components such as the processor 211 are connected to an internal bus, etc. so that these components can communicate with each other.

The hardware configuration of the mobile communication terminal 10 is not limited to the configuration illustrated in FIG. 10. The mobile communication terminal 10 may include hardware not illustrated or may be configured without the input-output interface 313 if desired. In addition, the number of components, such as the number of processors 311, included in the server apparatus 10 is not limited to the example illustrated in FIG. 10. For example, a plurality of processors 311 may be included in the mobile communication terminal 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display device and an input device not illustrated. For example, the display device is a liquid crystal display or the like. For example, the input device is a device, such as a keyboard or a mouse, which receives user operations.

The communication interface 314 is a circuit, a module, or the like for performing communication with other apparatuses. For example, the communication interface 314 includes a wireless communication circuit, a NIC (Network Interface Card), or the like.

The functions of the mobile communication terminal 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the money registry machine 20, and so on can each be configured by an information processing apparatus, and the basic hardware configuration of the money registry machine 20 is the same as that of the mobile communication terminal 10. Thus, description of the basic hardware configuration of the money registry machine 20 will be omitted.

The mobile communication terminal 10, the mobile communication terminal being an information processing apparatus, includes a computer and can realize its functions by causing the computer to execute a program. In addition, the mobile communication terminal 10 executes a code display method by using the program.

### Variations

Note that the configurations, operations, or the like of the mobile communication terminal 10 described in the above example embodiments are examples and are not intended to limit the configuration or the like of the mobile communication terminal 10.

The above example embodiments describe controlling displaying and undisplaying of a code that is used for payment. However, a code targeted by the present application is not limited to the code used for payment. For example, a ticket for entering an event venue, such as a sporting event or a concert, may be targeted.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

A part or the entirety of the example embodiments described above may be described as in the following supplementary notes, but is not limited to the followings.

### Supplementary Note 1

A mobile communication terminal, including:

a reception unit that accepts an instruction to display a code by using an input/output unit; and
a display control unit that causes the code, the code being undisplayed, to be displayed when the display control unit detects a trigger indicating that the code is ready to be read.

### Supplementary Note 2

The mobile communication terminal according to supplementary note 1, wherein the trigger is a state or a signal of the mobile communication terminal that the mobile communication terminal detects.

### Supplementary Note 3

The mobile communication terminal according to supplementary note 2, wherein the trigger is a state in which a control unit of the mobile communication terminal detects that a touch panel of the mobile communication terminal is facing downward by using an attitude detection unit.

### Supplementary Note 4

The mobile communication terminal according to supplementary note 2, wherein the trigger is a state in which a control unit of the mobile communication terminal detects a laser light emitted from a code reader of a code reader or a hand scanner by using an imaging unit.

### Supplementary Note 5

The mobile communication terminal according to supplementary note 2, wherein the trigger is a state in which a control unit of the mobile communication terminal detects that a touch panel of the mobile communication terminal is close to a code reader of a code reader or a hand scanner by using an illuminance detection unit.

### Supplementary Note 6

The mobile communication terminal according to supplementary note 2, wherein the trigger is a state in which a control unit of the mobile communication terminal detects that a predetermined sound is generated by using a sound collection unit.

### Supplementary Note 7

The mobile communication terminal according to supplementary note 2, wherein the trigger is a signal that a control unit of the mobile communication terminal receives from a code reader by using a communication unit.

### Supplementary Note 8

The mobile communication terminal according to any one of supplementary notes 2 to 7, wherein the display control unit undisplays the code by removing the code from a screen.

### Supplementary Note 9

The mobile communication terminal according to any one of supplementary notes 2 to 7, wherein the display control unit makes the code, the code being displayed, invisible by using a mask image.

### Supplementary Note 10

The mobile communication terminal according to any one of supplementary notes 2 to 7, wherein a control unit of the mobile communication terminal notifies a user by vibrating the mobile communication terminal by using a vibration unit when the code is made visible.

### Supplementary Note 11

The mobile communication terminal according to any one of supplementary notes 2 to 7, wherein a control unit of the mobile communication terminal notifies a user by turning on a light included in an imaging unit when the code is made visible.

### Supplementary Note 12

The mobile communication terminal according to any one of supplementary notes 2 to 7, wherein a control unit of the mobile communication terminal notifies a user by generating a sound from a speaker included in the mobile communication terminal when the code is made visible.

### Supplementary Note 13

A code display method, including:

monitoring, by using a code monitoring unit, a screen displayed on a touch panel of an input/output unit and detects whether or not a code is displayed;
undisplaying, by using an undisplay unit, the code when the code is detected; and
causing, by using a display control unit, the undisplayed code to be displayed when the display control unit detects a trigger indicating that the mobile communication terminal is ready for the code to be read.

### Supplementary Note 14

A computer-readable storage medium storing a program for a mobile communication terminal, wherein the program causes the mobile communication terminal to function as;

a code monitoring unit that monitors a screen displayed on a touch panel of an input/output unit and detects whether or not a code is displayed;
an undisplay unit that undisplays the code when the code is detected; and
a display control unit that causes the undisplayed code to be displayed when the display control unit detects a trigger indicating that the mobile communication terminal is ready for the code to be read.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### Reference Signs List

10 mobile communication terminal
11 reception unit
12 display control unit
20 money registry machine
101 control unit
102 input/output unit
102A touch panel
102B imaging unit
102C sound collection unit
102D vibration unit
103 storage unit
103A OS
103B undisplay application
103C general application
104 detection unit
104A attitude detection unit
104B illuminance detection unit
105 communication unit
105A mobile phone line communication unit
105B wireless LAN communication unit
105C near field communication unit
201 POS control unit
202 POS input/output unit
203 POS storage unit
204 POS communication unit
205 code reader
206 hand scanner
311 processor
312 memory
313 input/output interface
314 communication interface
501 first example undisplayed screen
502 area
503 consent button
601 second example undisplayed screen
602 mask image
701 display screen
702 code
801 tablet
802 calculation screen
803 confirmation pop-up
804A code display button
804B code undisplay button

What is claimed is:

1. A mobile communication terminal, comprising:
at least one memory storing a set of instructions; and
at least one processor configured to execute the set of instructions to:
accept an instruction to display a code by using an input/output device; and
cause the code, the code being undisplayed, to be displayed when a trigger, the trigger indicating that the code is ready to be read, is detected.

2. The mobile communication terminal according to claim 1, wherein the trigger is a state or a signal of the mobile communication terminal that the mobile communication terminal detects.

3. The mobile communication terminal according to claim 2, wherein the trigger is a state in which the mobile communication terminal detects that a touch panel of the mobile communication terminal is facing downward by using an attitude detection device.

4. The mobile communication terminal according to claim 2, wherein the trigger is a state in which the mobile communication terminal detects a laser light emitted from a code reader or a hand scanner by using an imaging device.

5. The mobile communication terminal according to claim 2, wherein the trigger is a state in which the mobile communication terminal detects that a touch panel of the mobile communication terminal is close to a code reader or a hand scanner by using an illuminance detection device.

6. The mobile communication terminal according to claim 2, wherein the trigger is a state in which the mobile communication terminal detects that a predetermined sound is generated by using a sound collection device.

7. The mobile communication terminal according to claim 2, wherein the trigger is a signal that the mobile communication terminal receives from a code reader by using a communication device.

8. The mobile communication terminal according to claim 2, wherein
the at least one processor is further configured to execute the set of instructions to undisplay the code by removing the code from a screen.

9. The mobile communication terminal according to claim 2, wherein
the at least one processor is further configured to execute the set of instructions to make the code, the code being displayed, invisible by using a mask image.

10. The mobile communication terminal according to claim 2, wherein
the at least one processor is further configured to execute the set of instructions to notify a user by vibrating the mobile communication terminal by using a vibration device when the code is made visible.

11. The mobile communication terminal according to claim 2, wherein
the at least one processor is further configured to execute the set of instructions to notify a user by turning on a light included in an imaging device when the code is made visible.

12. The mobile communication terminal according to claim 2, wherein
the at least one processor is further configured to execute the set of instructions to notify a user by generating a sound from a speaker included in the mobile communication terminal when the code is made visible.

13. A code display method, comprising:
monitoring a screen displayed on a touch panel of an input/output device and detects whether or not a code is displayed;
undisplaying the code when the code is detected; and
causing the undisplayed code to be displayed when a trigger, the trigger indicating that the mobile communication terminal is ready for the code to be read, is detected.

14. A non-transitory computer-readable storage medium storing a program that causes a computer mounted on a mobile communication terminal;
monitor a screen displayed on a touch panel of an input/output device and detects whether or not a code is displayed;
undisplay the code when the code is detected; and
cause the undisplayed code to be displayed when a trigger, the trigger indicating that the mobile communication terminal is ready for the code to be read, is detected.
